(19) United States
(12) Patent Application Publication
(10) Pub. No.: US 2025/0327145 A1
(43) Pub. Date: Oct. 23, 2025

(54) METHOD AND DEVICE FOR HEATING A VEHICLE WHEEL

(71) Applicant: Maschinenfabrik Alfing Kessler GMBH, Aalen (DE)

(72) Inventor: Andreas Zahn, Riegel (DE)

(73) Assignee: Maschinenfabrik Alfing Kessler GMBH, Aalen (DE)

(21) Appl. No.: 18/719,654

(22) PCT Filed: Dec. 21, 2022
(86) PCT No.: PCT/EP2022/087241

§ 371 Date: Nov. 4, 2024

(30) Foreign Application Priority Data
Dec. 22, 2021 (DE) 10 2021 134 233.3

(51) Int. Cl. C21D 1/42; C21D 9/34; H05B 6/10; H05B 6/38; H05B 6/40

(52) U.S. Cl. CPC C21D 1/42; C21D 9/34; H05B 6/102; H05B 6/38; H05B 6/40

(57) ABSTRACT

The invention relates to a method for heating a vehicle wheel, in particular as a preparation for a subsequent shaping method, in which at least a part of the vehicle wheel is heated by means of inductive heating using an inductor.

### CROSS-REFERENCE TO RELATED APPLICATION

The present application claims the priority of German patent application No. 102021134233.3 filed on Dec. 22, 2021 and PCT application No. PCT/EP2022/087241 filed on December 21,2022, the content of which is incorporated herein in full by reference.

### TECHNICAL FIELD

The invention relates to a method for heating a vehicle wheel, in particular as preparation for a subsequent forming process. Furthermore, the invention relates to a device for heating a vehicle wheel, in particular as preparation for a subsequent forming process.

### SUMMARY

Various casting methods for the production of vehicle wheels are known from the general state of the art. The vehicle wheels cast by these methods can then be further processed by means of so-called flow forming or the flow forming process, i.e., a rolling of the rim of the vehicle wheel. The flow forming process leads to a compaction of the material and thus a greater stability and strength of the material. Furthermore, the flow forming process saves material, which allows lighter and more resistant vehicle wheels to be produced. Another advantage of this known method is that one and the same basic shape of a vehicle wheel produced by casting can be used to create a number of different widths of the wheel, which reduces the production costs of such vehicle wheels.

To carry out the flow forming process, the vehicle wheels must be heated to a certain temperature. Up to now, this has been carried out in a suitable oven, usually operated with gas, which however leads to a very high energy consumption. An additional disadvantage of this procedure is the use of combustion gases in the heating ovens, which not only leads to very high costs but also entails a very high consumption of CO₂. Furthermore, vehicle wheels produced in a certain manner may cause problems if certain regions of the wheels are heated to excessive temperatures.

It is therefore the object of the present invention to provide a method and a device for heating a vehicle wheel with which the vehicle wheel can be heated in a simple, reliable and environmentally friendly manner.

According to the invention, this object is achieved by the features specified in claim 1. The method according to the invention, in which at least a part of the vehicle wheel is heated by means of inductive heating using an inductor, brings with it many advantages compared to the methods used so far. For instance, inductive heating generates the required temperature directly in the component itself and not in a much larger space, resulting in a much lower energy requirement than with the known methods. Furthermore, this also leads to a significantly reduced emission of CO₂ and thus to a better environmental balance of the method according to the invention.

Another advantage is that the inductor used for the inductive heating can be operated with electric current, which compared to the use of gas not only contributes to protecting the environment but also brings financial advantages. This financial advantage is increased further by the significantly better efficiency of inductive heating compared to heating in an oven. Another advantage of using an inductor for heating the vehicle wheel is that the method is easier to carry out in this way. Furthermore, there are advantages in terms of the space requirement, because an induction device takes up much less space than for example a gas-operated oven.

In a very advantageous development of the invention it can be provided that essentially only the rim of the vehicle wheel is heated. On the one hand, this leads to an even lower energy requirement, because a much lower mass has to be heated than with known solutions. On the other hand, the inductor used for carrying out the method can thus be of a simpler structural design and be more cost-effective to produce. This embodiment may be advantageous in particular in the case of vehicle wheels produced by means of die-casting, because as far as possible certain regions of the vehicle wheel should not be heated too much.

If in a further advantageous embodiment of the method according to the invention the inductor is arranged inside the rim, this leads to more uniform heating of the vehicle wheel. In addition, a simpler structural design of the inductor can be made possible in this case too, and this can in turn lead to a reduction in costs. Since the inner side of the rim usually has a more even contour than the outer side, the turns of the inductor can be made relatively easily. Also, the movement of the inductor to arrange it inside the rim is easier than in the case of an inductor which is arranged on the rim from the outside, which is not shown.

Furthermore, it may be provided that the spokes and/or the hub of the vehicle wheel are cooled. This helps to keep the specified regions of the vehicle wheel which as far as possible should not be heated too much within the desired temperature ranges. A particularly simple possibility for cooling the spokes and/or the hub of the vehicle wheel is obtained if a cooling medium is applied to the spokes and/or the hub during the heating.

Another advantageous embodiment of the method according to the invention may be that at least a part of the vehicle wheel is heated for a duration of 20 seconds to 5 minutes preferably 40 seconds to 3 minutes. Such a period of time has proven to be particularly advantageous in terms of uniform heating of the regions of the vehicle wheel to be heated. In order to be able to carry out the subsequent forming process, in particular the so-called flow forming, in the desired manner, a further advantageous embodiment of the invention may be that at least a part of the vehicle wheel is heated to a temperature of 250 to 400° C., preferably 300 to 360° C.

Furthermore, it may be provided that the vehicle wheel and/or the inductor is rotated during the heating. This leads to a very uniform heating of the vehicle wheel and prevents potentially excessive heat development in certain regions of it, so that a high quality of the vehicle wheel processed by the method according to the invention can be maintained.

If in a further advantageous embodiment of the method according to the invention the temperature of at least a part of the vehicle wheel is monitored during the heating, not only is overheating of the vehicle wheel avoided, but also a constant quality of the wheel is ensured.

A further advantageous embodiment of the method according to the invention may be that electricity from renewable energy sources is used for operating the inductor. This ensures a CO₂-neutral process and thus serves the protection of the environment.

A device for heating a vehicle wheel is specified in claim 11. The device according to the invention can be used particularly advantageously in the method according to the invention and ensures that it is easily carried out. Furthermore, the device according to the invention is simple and cost-effective to produce.

A very advantageous embodiment of the device according to the invention may be that the inductor is formed as a toroidal inductor, in particular a multi-turn toroidal inductor, adapted to an inner region of the rim of the vehicle wheel. Such a multi-turn toroidal inductor ensures uniform heating of the entire rim of the vehicle wheel and can be of a relatively simple structural design and thus more cost-effective to produce.

Furthermore, the device according to the invention may have a device for supplying a cooling medium to the spokes and/or the hub of the vehicle wheel. This allows very easy cooling of the spokes and/or the hub of the vehicle wheel to keep these regions at the desired temperatures despite the heating.

A further advantageous embodiment of the device according to the invention may be that a device for rotating the vehicle wheel and/or the inductor is provided. By means of such a device, uniform heating of the vehicle wheel can be achieved.

If in a further advantageous embodiment a device for monitoring the temperature of the vehicle wheel is provided, a simple possibility for avoiding potential overheating of the vehicle wheel is obtained.

### BRIEF DESCRIPTION OF THE FIGURES

An exemplary embodiment of the invention is presented in principle below with reference to the drawing.

FIG. 1 shows a very schematic representation of an installation used in a method for producing a vehicle wheel, part of which is the device according to the invention for heating the vehicle wheel;

FIG. 2 shows a side view of a device according to the invention for heating a vehicle wheel;

FIG. 3 shows a section according to the line III-III from FIG. 2;

FIG. 4 shows a view according to the arrow IV from FIG. 2; and

FIG. 5 shows a perspective view of the device according to the invention.

### DETAILED DESCRIPTION OF THE INVENTION

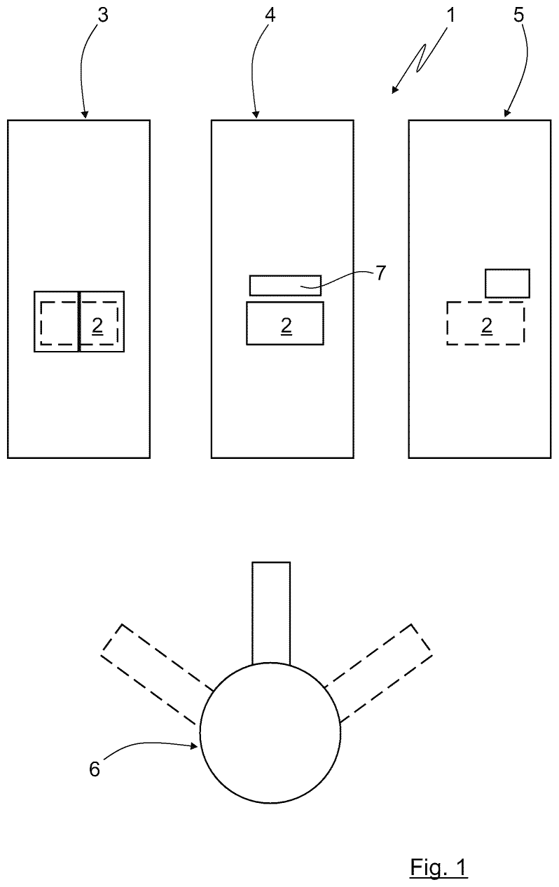

FIG. 1 shows in a very schematic representation an installation 1 for heating a vehicle wheel 2, which is likewise only very schematically shown in FIG. 1. The installation 1 has a casting device 3 for producing the vehicle wheel 2 by means of casting, a device 4 for heating the vehicle wheel 2 and a forming device 5, in particular for carrying out a flow forming process on the vehicle wheel 2. All of the devices 3, 4 and 5 are only very schematically indicated in FIG. 1.

The installation 1 also has a likewise only very schematically indicated handling device 6, with which the vehicle wheels 2 can be transported between the devices 3, 4 and 5. In the present case, the handling device 6 is a multi-axis robot.

While the casting device 3 and the forming device 5 can be of a design known per se, and therefore the devices and the method steps carried out with them are not described in more detail below, the device 4 with which a method for heating a vehicle wheel can be carried out is described more specifically below.

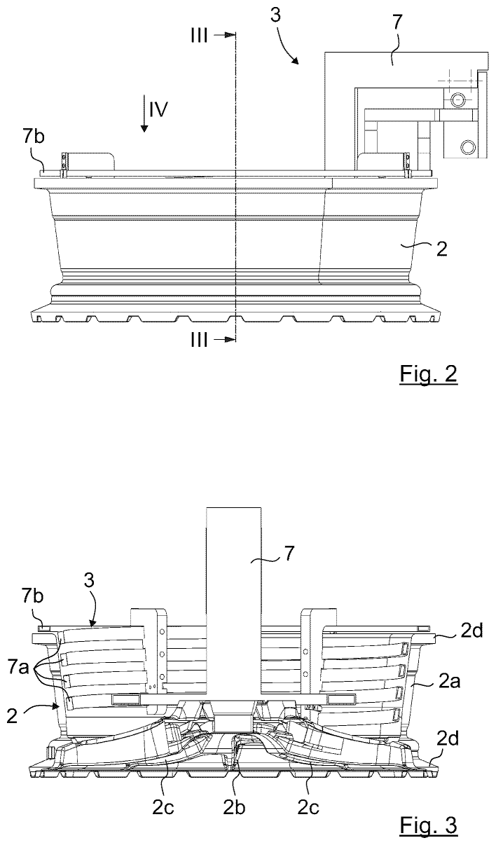

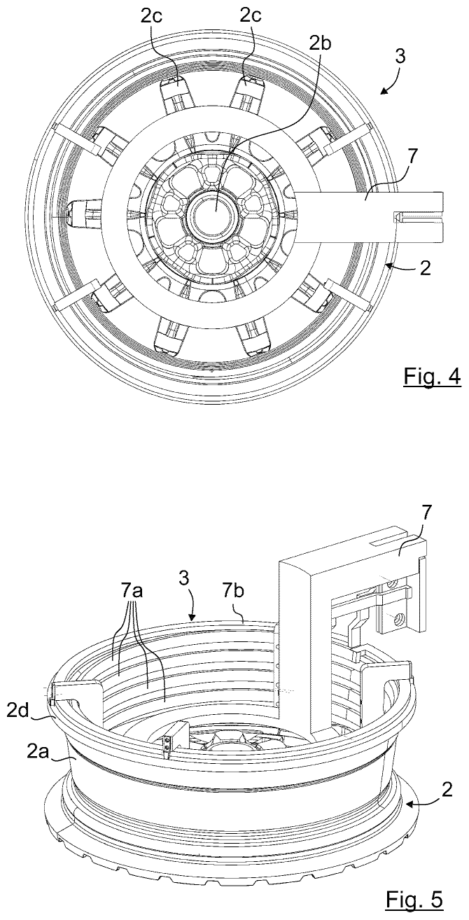

The device 4 for heating the vehicle wheel 2 is shown in various views in FIGS. 2 to 5. The device 4 has an inductor 7, which is at least partially adapted to the shape of the vehicle wheel 2. In the present case, the inductor 7 is a multi-turn toroidal inductor, the design of which can be seen in particular in FIGS. 3 and 5, and which will be described in more detail later.

The vehicle wheel 2, which can be seen best in the representation of FIG. 3, has a circumferential rim 2a in a known manner, a hub 2b forming the central region of the vehicle wheel 2, a number of spokes 2c connecting the hub 2b to the rim 2a and two rim flanges 2d forming the lateral boundary of the rim 2a.

Preferably, the inductor 7 is designed such that essentially only the rim 2a of the vehicle wheel 2 is heated. During the process for inductively heating the vehicle wheel 2 carried out with the inductor 7, the inductor 7 is arranged inside the vehicle wheel 2 in the exemplary embodiment shown, and thereby heats the rim 2a from its inner side. For this purpose, the inductor 7 is adapted to the inner region of the rim 2a of the vehicle wheel 2.

The inductor 7, which as indicated above is formed as a multi-turn toroidal inductor, has a number of turns 7a arranged inside the rim 2a and one turn 7b assigned to the rim flange 2d facing away from the spokes 2c. The diameter of the individual turns 7a may decrease in the direction of the spokes 2c if, as in the present case, the rim 2a has a certain conical shape. The other components of the inductor 7 are not described in more detail herein because they are generally known.

Preferably, the vehicle wheel 2 or at least a part of the vehicle wheel 2, specifically the rim 2a, is heated inductively for a duration of 20 seconds to 5 minutes, preferably 40 seconds to 3 minutes. Furthermore, the temperature to which the vehicle wheel 2 or the rim 2a is inductively heated by means of the inductor 2 is 250 to 400° C., preferably 300 to 360° C. The temperature to which the rim 2a is heated can be set by the converters coupled to the inductor 7 on the, which are not shown.

By means of a device, not shown, for monitoring the temperature of the vehicle wheel 2, the temperature of the vehicle wheel 2 can be monitored during the heating. This device may be for example a thermal imaging camera or a pyrometer.

The vehicle wheel 2 and/or the inductor 7 can be rotated during the heating. For this purpose, the device 4 may have a device, likewise not shown, for rotating the vehicle wheel 2 and/or the inductor 7.

Furthermore, a device for supplying a cooling medium to the spokes 2c and/or to the hub 2b of the vehicle wheel 2 may be provided to cool the spokes 2c and/or the hub 2b of the vehicle wheel 2 during the inductive heating. For example, this device may be formed as a cooling spray. By means of the cooling medium, the temperature of the hub 2b and/or the spokes 2c can be set to the desired level.

In a way known per se, in the inductive heating eddy currents are induced in the rim 2a of the vehicle wheel 2 by an alternating electromagnetic field of the inductor 7 and converted into heat. Due to the good thermal conductivity properties of the aluminum material, the desired region, in the present case the rim 2a, heats up in a comparatively short time. The coupling distance between the inductor 7 and the vehicle wheel 2 may be for example 2 to 6 mm. Electricity from renewable energy sources is preferably used for operating the inductor 7.

1. A method for heating a vehicle wheel, in particular as preparation for a subsequent forming process, wherein only the rim of the vehicle wheel (2) is heated by means of inductive heating using an inductor for a duration of 20 seconds to 5 minutes.

2. The method as claimed in claim 1, wherein the inductor is arranged inside the rim.

3. The method as claimed in claim 1, wherein the spokes and/or the hub of the vehicle wheel are cooled.

4. The method as claimed in claim 3, wherein a cooling medium is applied to the spokes and/or the hub during the heating.

5. The method as claimed in claim 1, wherein at least a part of the vehicle wheel is heated to a temperature of 250 to 400° C.

6. The method as claimed in claim 1, wherein the vehicle wheel and/or the inductor is rotated during the heating.

7. The method as claimed in claim 1, wherein at least a part of the vehicle wheel is monitored during the heating.

8. The method as claimed inclaim 1, wherein electricity from renewable energy sources is used for operating the inductor.

9. (canceled)

10. (canceled)

11. A device for heating a vehicle wheel, in particular as preparation for a subsequent forming process, comprising:
an inductor which is at least partially adapted to a shape of a vehicle wheel, the inductor being adapted to heat essentially only a rim of the vehicle wheel by means of inductive heating for a duration of 20 seconds to 5 minutes.

12. The device as claimed in claim 9, the inductor is formed as a toroidal inductor adapted to an inner region of the rim of the vehicle wheel.

13. The device as claimed in claim 9, wherein the inductor being adapted to supply a cooling medium to the spokes and/or the hub of the vehicle wheel.

14. The device as claimed in claim 9, further comprising a device for rotating the vehicle wheel and/or the inductor.

15. The device as claimed claim 9, further comprising a device for monitoring the temperature of the vehicle wheel.

16. The method as claimed in claim 1, wherein the vehicle wheel is heated by means of inductive heating using an inductor for a duration of 40 seconds to 3 minutes.

17. The method as claimed in claim 1, wherein the vehicle wheel is heated to a temperature of 300 to 360° C.

18. The method as claimed in claim 2 wherein the spokes and/or the hub of the vehicle wheel are cooled.

19. The method as claimed in claim 4, wherein the vehicle wheel and/or the inductor is rotated during the heating.

20. The method as claimed in claim 6, wherein the temperature of at least a part of the vehicle wheel is monitored during the heating.

21. The method as claimed in claim 18, wherein electricity from renewable energy sources is used for operating the inductor.

22. The method as claimed in claim 1 wherein the inductor further comprising a multi-turn toroidal inductor.
